(19) United States
(12) Patent Application Publication
(10) Pub. No.: US 2009/0160277 A1
(43) Pub. Date: Jun. 25, 2009

(54) Fluid Dynamic Pressure Bearing

(75) Inventor: Rikuro Obara, Kitasaku-gun (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MINEBEA CO., LTD., Nagano (JP)

(21) Appl. No.: 11/628,385

(22) PCT Filed: May 27, 2005
(86) PCT No.: PCT/US2005/018641

§ 371 Date: Dec. 1, 2006

(30) Foreign Application Priority Data
Jun. 1, 2004 (JP) 2004-163607
May 11, 2005 (JP) 2005-138649

(51) Int. Cl. H02K 7/08; F16C 32/06

(52) U.S. Cl. 310/90; 384/120

(57) ABSTRACT

A fluid dynamic bearing (1) with a rotating shaft (3) inserted into a sleeve (2) fitted into a case (7) is disclosed. Tree rotating shaft (3) rotates freely without contact with the sleeve (2) by means of dynamic pressure force generated by the lubricant fluid that fills the gap formed around the rotating shaft (3). An adhesive groove (2c) is formed around the entire outer circumferential surface of the sleeve (2). At least one hole (7a) facing the adhesive groove (2c) is formed in case (7), and case (7) and sleeve (2) are; adhered by the injection of an adhesive (13) into adhesive groove (2c) from the hole (7a). The fluid dynamic pressure bearing, manufactured in this manner provides a high-quality bearing that is easy to construct, that can be adapted to low-cost manufacturing, and that can maintain dimensional and structural accuracy and in which the case (7) and sleeve (2) can be reliably adhered together with the adhesive (13). Such bearing will maintain long-term airtightness of the joint between the sleeve (2) and the case (7) and prevent leakage of lubricant fluid during manufacture. The bearing can be used for a spindle and other compact motors for driving memory devices for magnetic discs and optical discs (such as a CD or a DVD), motors for polygon mirrors used for scanning processes of laser beam printers, and for small motors for use such as in axial flow fans.

This application claims priority based on the following Japanese patent applications: 2004-163607, filed Jun. 1, 2004; and 2005-138649, filed May 11, 2005.

### BACKGROUND OF THE INVENTION

1. Field of the Invention

This invention relates to fluid dynamic pressure bearings for a spindle and other compact motors for driving memory devices for magnetic discs and optical discs (such as a CD or a DVD), driving motors for polygon mirrors used for scanning processes of laser beam printers, and for small driving motors for use such as in axial flow fans.

2. Description of the Related Art

In recent years, in regards to memory devices for magnetic and optical discs used in computer hardware, the demand for smaller, thinner, and lighter products with high density memory capacity has become strong, and market pressure to lower costs has also increased. Because of this, there is a large demand to increase speed and rotational accuracy and lower costs for spindle motors used to rotate and drive the discs of such memory devices.

As a result of efforts to meet these demands, there has been a shift towards use of fluid dynamic pressure bearings instead of conventional ball bearings in spindle motors. However, as further miniaturization occurs, it becomes harder to secure the dimensional accuracy and assembling accuracy of the parts that constitute the fluid dynamic pressure bearings, and it is getting harder to mass-produce the product at low costs.

Unexamined patent application publication 2004-003582 proposes making some of the parts as pressed molded parts to lower the cost of fluid dynamic pressure bearings. Another proposal was made in unexamined patent application publication 2000-175399 to secure the dimensional accuracy and assembly accuracy.

Incidentally, in a fluid dynamic pressure bearing, when a sleeve is fitted to a case, the high precision of the inner circumference of the sleeve (size of the inner diameter, roundness, cylindricality) must, of course, be maintained, and the case and sleeve must be completely fixed together, the lubricant cannot leak out through both the contact surfaces of the case and sleeve fitted to each other, and the fitted section must be airtight to secure the lubricant.

Here, FIG. 8 and FIG. 9 each present examples of conventional fluid dynamic pressure bearings. Also, FIG. 8 and FIG. 9 are vertical cross-sectional views showing the assembly condition of the case and sleeve of the conventional fluid dynamic pressure bearings.

In the example presented in FIG. 8, a sleeve 102 is press fitted into a cylindrical case 107, and in the example presented in FIG. 9, a convex portion 207a forms a portion of the surface of the interior circumference of a case 207, and by press fitting the convex portion 207a and the exterior circumference of sleeve 202, the fit length between the two is shortened. Through this, the length where the pressure arises at the time of press fitting is kept short and so reduces the effect on the accuracy of the size of the diameter of the inner circumference of the sleeve 202. At the same time, an adhesive 213 is injected into the gap that arises between the inner circumference of case 207 and the outer circumference of sleeve 202 through convex portion 207a, and this realizes a firm fixing of the sleeve 202 and case 207 and completely fills the gap through the even distribution of the adhesive 213.

In the example presented in FIG. 8, the method of fixing the case 107 to the sleeve 102 by applying pressure and fixing the two on their fitted surface is adopted. However with this method the interference between the case 107 and the sleeve 102 must be large and so the dimensional accuracy becomes distorted by the high pressure force and the galling of the fitted surfaces, therefore, with this method, it is difficult to maintain high accuracy of the inner circumference of the said sleeve 102, and, at the same time, to maintain airtightness at the fitted surfaces of sleeve 102 and case 107.

Also, to suppress the distortion of the dimensional accuracy of sleeve 102 caused by pressure, the interference must be small. Even if the method of fitting the parts by previously coating the fitted surface with an adhesive is adopted to keep the sleeve 102 and case 107 firmly adhered together, the applied adhesive is not evenly coated on the fitted surface because part of adhesive is taken outward during fitting, and the adhesion failure will make it impossible for sleeve 102 and case 107 to be firmly adhered together or the outwardly taken adhesive will adhere to parts other than the fitted surface, thereby generating a contamination problem in that area.

Moreover, because the adhesive is not evenly coated on the fitted surface, the gap between the inner circumference of case 107 and the outer circumference of sleeve 102 will not be completely sealed, and it becomes harder to prevent the lubricating fluid from leaking to the outside, and to ensure that the proper amount of the lubricating fluid will be maintained.

On the other hand, in the example presented in FIG. 9, for the manufacturing of case 207, which has the protruding portion 207a within its inner circumference, turning process is required to form protruding portion 207a. In order to lower the cost of manufacturing, turning process facility that will ensure processing accuracy is needed. Additionally, there are problems regarding reducing the number of process steps, and processing time, thus posing obstacles to low-cost mass production.

### SUMMARY

The present invention solves the problems of the conventional fluid dynamic pressure bearings and maintains dimensional and geometric accuracy of the sleeve when it is fitted in the case. The present invention also ensures that the case and sleeve are reliably adhered together with the adhesive, and at the same time offers a fluid dynamic pressure bearing that is high in quality, easy to construct and is suitable for low-cost manufacturing, and is able to maintain long-term airtightness, thereby preventing the leakage of lubricant fluid.

Moreover, the present invention provides a recording disk drive device having a spindle motor that can maintain a high degree of reliability and wherein the contamination by the adhesive agent used to bond the fluid dynamic pressure bearing cases and sleeves is prevented. The present invention also provides a spindle motor that can be used in other applications such as an axial flow fan and wherein the contamination by the adhesive agent used to bond the fluid dynamic pressure bearing cases and sleeves is prevented.

In the present invention, after the case is fitted to the sleeve during the assembling of the fluid dynamic pressure bearing, the adhesive is injected into the adhesive groove of the sleeve, from the exterior circumference surface of the case through the opening formed in the case. With this adhesive, the inner circumference surface of the case and the outer circumference surface of the sleeve are adhered together, firm and airtight, and thus the gap between the two parts is completely sealed by the adhesive, the lubricant is prevented from leaking from the gap, and thereby the lubricant that is added to the inside of the fluid dynamic pressure bearing is completely retained in the inside. Also, unlike in the case of the conventional method of fitting by coating with an adhesive the fitted surface previously to the fitting of the sleeve and the case, problems such as the inadequate adherence of the sleeve and the case due to adhesion failure when the adhesive is partially carried outward during the fitting and is spread unevenly on the fitting surface, and the contamination of parts that arises when the outwardly carried adhesive adheres to parts other than the fitting surface do not occur. Also, because problems that occur during the assembly process, such as the handling, are mitigated, manufacturing efficiency is increased, making mass production of the fluid dynamic pressure bearing possible.

The case of the present invention, including the formation of the adhesive holes therein, is produced with precision press processing, which obviates the need for conventional cutting processes. The manufacturing efficiency increases due to the reduction in process steps and it becomes possible to mass-produce at low cost.

In the present invention, during the fitting of the case to the sleeve, when the wall thickness of the sleeve is thin and the sleeve is prone to becoming more easily deformed by the pressure raised during press fit, or when press fit cannot be applied with the established interference, by leaving some clearance between the case and the sleeve when fitting the two, it is possible to further improve quality and productivity because the distortion of the dimensional and geometric accuracy (size of the inner diameter, circularity, and cylindricality) of the interior surface of the hole of the sleeve resulting from the pressure is eliminated, and the complete sealing ability of the fitted gap section is reliably maintained by the selection of an adhesive viscosity that can best fill the fitted gap section.

The injecting of the adhesive agent from the hole formed in the side of the case of the fluid dynamic pressure bearing provided in a spindle motor into the adhesive groove of the sleeve, eliminates the problem of contamination of the spindle motor by the adhesion of the adhesive agent in areas other than those desired is prevented. And a high degree of spindle motor reliability is assured by the strong adhesive bond between the case and the sleeve.

By injecting an adhesive agent into the adhesive groove of the sleeve from a hole formed in the side of the case of the fluid dynamic pressure bearing provided in the spindle motor of a recording disk drive device, the problem of contamination of the recording disk drive devices with adhesive agent in locations other than those desired is prevented. And a high degree of reliability of the recording disk driving device is assured by the strong adhesive agent bond between the case and sleeve.

Further features and advantages will appear more clearly on a reading of the detailed description, which is given below by way of example only and with reference to the accompanying drawings wherein corresponding reference characters on different drawings indicate corresponding parts.

### BRIEF DESCRIPTION OF THE DRAWINGS

FIG. 1 is the vertical cross-sectional view of an assembly of a case and sleeve of a fluid dynamic bearing of the present invention.

FIG. 2 is the vertical cross-sectional view of the fluid dynamic bearing of the present invention.

FIG. 3 is the cross-sectional view along line A-A of FIG. 2.

FIG. 4 is the cross-sectional view along line B-B of FIG. 2.

FIG. 5 is the cross-sectional view along line C-C of FIG. 2.

FIG. 6 is the cross-sectional drawing of a spindle motor of the present invention.

FIG. 7 is the side cross-sectional drawing of an exemplary hard disk drive device of the present invention.

FIG. 8 is a cross-sectional view of an embodiment of a conventional fluid dynamic bearing.

FIG. 9 is a cross-sectional view of another embodiment of a conventional fluid dynamic bearing.

### DESCRIPTION OF THE PREFERRED EMBODIMENT

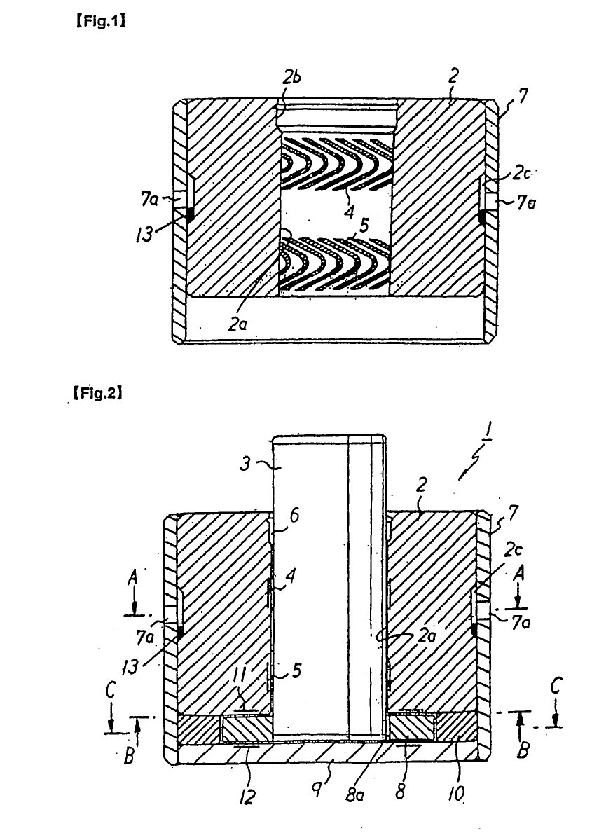

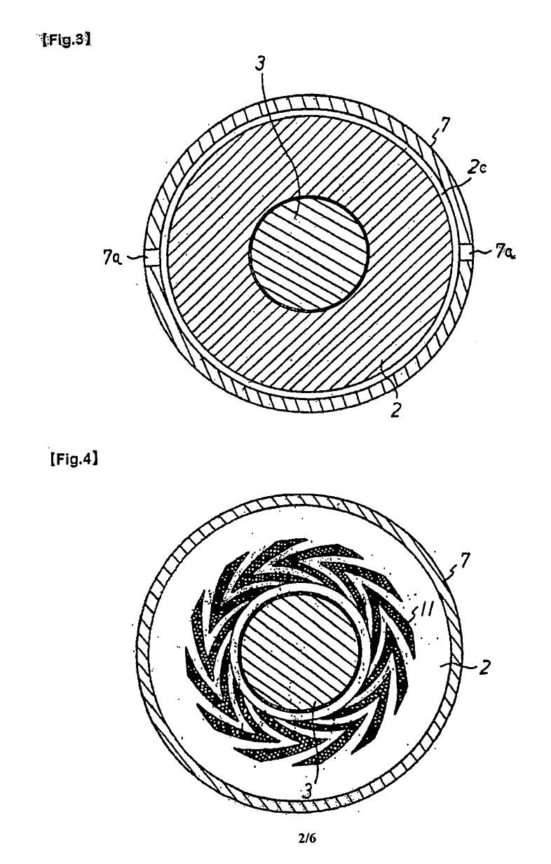

FIG. 2 shows a fluid dynamic bearing 1 having a cylindrical sleeve 2. A rotating shaft 3 (for example, in this embodiment, a spindle of the spindle motor) is inserted into a round hole 2a of the sleeve 2, and a minute radial gap with a ring-shaped plan view section is formed between the inner circumferential surface of round hole 2a and the outer circumferential surface of rotating shaft 3. As presented in FIG. 1, on top and bottom sections separated in the axial direction (i.e., upward and downward direction) of the inner circumferential surface of round hole 2a of sleeve 2, dynamic pressure generating herringbone-shaped grooves 4 and 5 are formed around the entire circumference. In the upper edge of the inner circumferential surface of the round hole 2a an expanded diameter section 2b, is provided (see FIG. 1) which forms a lubricant reservoir 6 having a ring-shaped plan view section with the outer circumferential surface of the rotating shaft 3 (see FIG. 2).

Also, in the middle position in the axial direction (upward, downward direction) of the outer circumferential surface of the sleeve 2, an adhesive groove 2c is formed around the entire circumference. A precision press processed cylindrical-shaped case 7 is fitted over sleeve 2 with clearance or light pressure. Here, in this embodiment, for the light press fitting, the interference is set to 2-3 μm.

Also, when the inner circumferential surface of case 7 and the outer circumferential surface of sleeve 2 are formed with high accuracy and are fitted with a sufficient clearance, the deformation of case 7 and sleeve 2 is prevented while sleeve 2 can slide and fit loosely into case 7, and high accuracy positioning for the sleeve 2 with respect to the case 7 can be obtained and the case 7 and sleeve 2 can be fixed with an adhesive, while an appropriate amount of load is provided at an arbitrary edge of the sleeve 2 in axial direction. This detail, in regards to the fluid dynamic pressure bearing 1, is important for mass producing with high efficiency and reliability, while maintaining the desired accuracy for the perpendicularity and concentricity of respectively, the case 7 and sleeve 2 with respect to the rotational axis of fluid dynamic bearing, the parallelism between the case 7 and sleeve 2, and the parallelism between the end surfaces of sleeve 2.

On the other hand, as shown in FIG. 2, a flange 8 is fitted onto the lower end of the aforementioned rotating shaft 3. On the lower edge of the inner circumference of case 7, an endplate 9, which covers the flange 8 from the bottom, is welded airtight. Also, between the sleeve 2 and endplate 9, a ring-shaped spacer 10, which forms a radial microgap with the flange 8 is built. The thickness of spacer 10 is slightly larger than the thickness of sleeve 8, so that, when the shaft 3 rotates, without contacting the sleeve 2 and endplate 9, axial microgaps are formed between the top side of flange 8 and the bottom side of sleeve 2, and between the bottom side of flange 8 and the top side of endplate 9. Spacer 10 is not always needed, and the use of spacer 10 can be omitted if a structure is made wherein an axial-direction distance equal to the thickness of flange 8 plus the size of microgaps is maintained between the sleeve 2 and endplate 9.

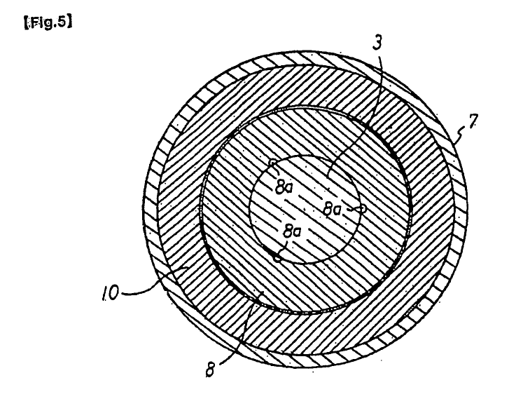

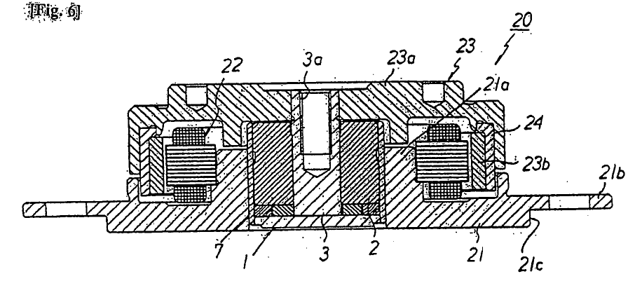

Also, on the end surface of sleeve 2 facing the flange 8, a spiral-shaped or herringbone-shaped dynamic pressure generating groove 11 as shown in FIG. 4 is formed, and similar dynamic pressure generating groove 12 is formed on the top surface of the endplate 9.

Two openings 7a are formed on the case 7. The openings 7a face each other in the diameter direction (see FIG. 3), and connect to the adhesive groove 2c formed on the outer circumference of sleeve 2. Also, for this embodiment, two openings 7a were formed, but it is sufficient to form only at least one, and the number is to be selected without any limitations, and the shape can be a circle, an ellipse or whatever shape which is best suited. Also, stainless steel was chosen as the material in this embodiment to produce the sleeve 2, rotating shaft 3, flange 8, end plate 9, and spacer 10, which form the said fluid dynamic pressure bearing 1. However, steel or stainless steel or other suitable material can be used.

To assemble the fluid dynamic bearing 1, the case 7 is fitted to the sleeve 2 by clearance fit or light press fit (for this embodiment, interference is 2-3 μm). A reservoir of an adhesive 13 is made by injecting adhesive 13 (for this embodiment, anaerobic thermosetting adhesive) into the adhesive groove 2c in sleeve 2 through the opening 7a formed in case 7. The adhesive 13 gets filled in the gap formed between the fitted surfaces of sleeve 2 and the case 7 by capillary action, and after the adhesive 13 has hardened enough, the entire circumference of the inner circumferential surface of case 7 and the outer circumferential surface of sleeve 2 is adhered firmly and airtight with the adhesive 13. The adhesive 13 completely seals the gap between the two, and a leakage of lubricant from the gap is completely prevented. The width (axial direction) of the adhesive groove 2c of sleeve 2 and the depth (diameter direction) are selected so that it is possible to maintain a sufficient reservoir of the adhesive 13.

The viscosity of adhesive 13 is chosen so that the adhesive 13 will reliably flow into the fitting portion of case 7 and sleeve 2 especially when the case 7 and sleeve 2 are fitted with a clearance.

When the rotating shaft 3 of a spindle motor rotates in the fluid dynamic pressure bearing 1 of the above construction, the dynamic pressure generating grooves 4 and 5 generate radial direction pressure in the lubricant within the radial gap, and the dynamic pressure generating grooves 11 and 12 generate axial direction pressure (thrust force) in the lubricant within the axial gap, and these pressures let the rotating shaft 3 avoid contact with the sleeve 2 and the endplate 9. As a result the rotating shaft 3 spins without coming in contact with the sleeve 2 and end plate 9.

In the above embodiment of the fluid dynamic pressure bearing 1, during its assembly, after the case 7 and sleeve 2 are fitted with a sufficient clearance or light pressure, the adhesive 13 is injected into the adhesive groove 2c in sleeve 2 from the opening 7a formed in case 7, from the outer circumferential surface of case 7. The case 7 and sleeve 2 are adhered together with the adhesive 13. The seal between the inner circumferential surface of case 7 and the outer circumferential surface of sleeve 2 is firm and airtight. The gap between the case 7 and sleeve 2 is completely sealed with the adhesive 13, and lubricant is prevented from leaking from the gap. Also, problems do not arise such as inadequate bonding of the sleeve and case due to uneven adhesive coating on the fitting surface, or contamination by the applied adhesive when it adheres to parts other than the fitting surface. Due to the problems in assembling process, including handling, are also remedied, production efficiency improves and mass-production can be achieved. Also, for the actual assembling process, the injecting of the adhesive 13 is done through discharge from a nozzle, automatically operated by a robot or the like (which is not shown in the figures). The hole 7a, which is formed on the case 7, provides the advantage of being usable as an accurate position locator for the place where the nozzle is inserted.

Also, because case 7 and sleeve 2 are completely adhered together with the adhesive 13, it is possible for the case 7 to be fitted with the sleeve 2 using clearance fit or light press fit thereby eliminating the distortion of the dimensional and structural accuracy (size of the inner diameter, circularity, and cylindricality) of the inner circumference of the cylindrical hole 2a of sleeve 2 that occurs due to pressure and the like and maintaining a high degree of reliability. Also, in this embodiment, the interference between case 7 and sleeve 2 can be set to a small 2-3 μm, below the 6-7 μm at which it was set to date.

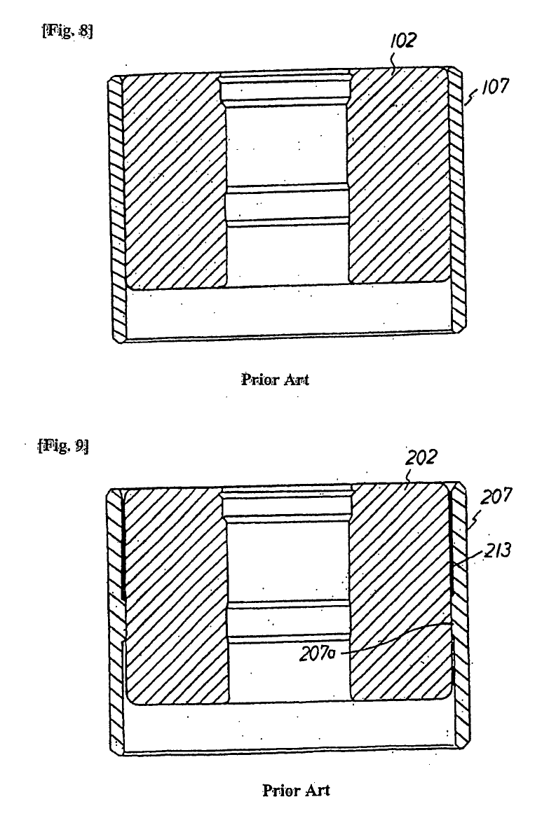

In addition, in this embodiment, because case 7, including the opening 7a are manufactured with precision press processing, the cutting process for the protruding portion 207a for the inner surface of case 207 necessary for conventional structures as shown in FIG. 9 became unnecessary, and mass production at low cost is now possible due to the gain in productivity from the reduction of the process steps.

FIG. 6 is a cross-sectional drawing of a schematic structure of a spindle motor 20 equipped with the fluid dynamic pressure bearing 1 according to the present invention. The spindle motor 20 is used as the motive source for a recording disk drive device.

The spindle motor 20 is equipped with a base 21 at the bottom part thereof, where a boss part 21a, which has a cylindrical shape extending in the upwards direction, is fabricated integratedly at the center part of said base 21. A stator 22, comprising coils wound onto a stator core, is affixed to the outer peripheral part of said boss part 21a.

The fluid dynamic pressure bearing 1 is secured by the fitting of the sleeve 2 and the case 7 on the inner peripheral surface of the boss part 21a of the base 21. A rotor 23 is supported by the fluid dynamic pressure bearing 1 so as to be able to rotate freely relative to the stator 22.

Here the rotor 23 is structured from a rotor hub 23a, which fits on the top end part of the shaft 3, and a rotor magnet 23b, which fits on the top cylindrical inner peripheral surface of the rotor hub 23a, with a yoke 24, interposed there between. The rotor magnet 23b produces a rotational magnetic field that works together with said stator 22 to drive rotationally the rotor 23.

Note that when the fluid dynamic pressure bearing 1 is fitted into the inner peripheral surface of the hub part 21a of the base 21, preferably a thermally curable adhesive agent, or the like, is used so that there will be no gap between the two. Moreover, although in the present example of embodiment the spindle motor 20 is formed as an outer-rotor-type motor, the present invention is not limited thereto, but rather may be structured as an inner-rotor-type motor.

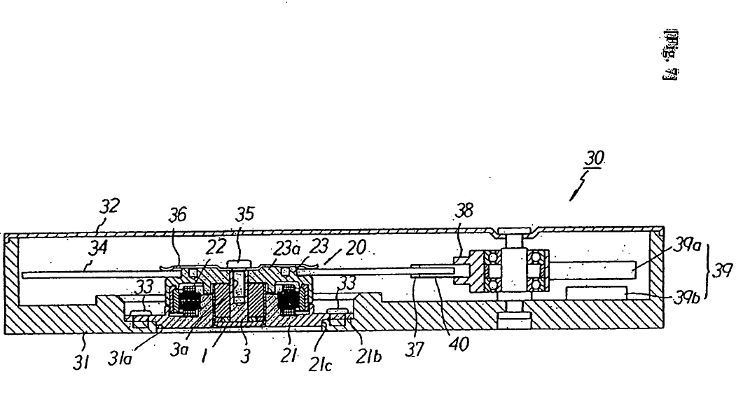

Note that a screw hole 3a is formed in the axial direction in the axial center part of the top part of said shaft 3, where a clamp member 36 that secures the hard disk 34, described below (see FIG. 7) is screwed on using this screw hole 3a. Furthermore, the spindle motor 20 is equipped with a flexible wiring board, not shown, where the provision of an electric current to the stator 22 from the output terminal of this flexible wiring board causes the rotor assembly, comprising the rotor 23 (the rotor hub 23a and the rotor magnet 23b), the shaft 3, and the like, to rotate relative to the stator 22.

In the spindle motor 20 that is equipped with the fluid dynamic pressure bearing 1, when the shaft 3 rotates, a dynamic pressure is generated in the lubricating oil by the dynamic pressure generating grooves 4 and 5 of the fluid dynamic pressure bearing 1 (see FIGS. 1 and 2). A dynamic pressure (a thrust force) in the vertical direction (the axial direction) is also generated in the lubricating oil by the dynamic pressure generating pressure grooves 11 and 12 (see FIG. 2). Thus, where the shaft 3 is supported in a stable, no-contact state, neither rising too far nor sinking.

Moreover, in the spindle motor 20 according to the present embodiment, an adhesive 13 (see FIGS. 1 and 2) is injected into the adhesive groove 2c in the sleeve 2 from holes 7a that are formed on the side surface of the case 7 of the fluid dynamic pressure bearing 1 so that the case 7 and the sleeve 2 will be adhered reliably to each other by this adhesive 13, thus insuring that there will be no problems with the soiling of said spindle motor 20 by the adherence of the adhesive 13 to parts other than the desired parts, and insuring high reliability of the spindle motor 20.

FIG. 7 is a side cross-sectional drawing showing the schematic structure of an exemplary hard disk drive device 30 according to the present invention. The hard disk drive device 30 is equipped with the aforementioned spindle motor as the motive source.

The hard disk drive device 30 according to the present example of embodiment has a housing 31, which house said spindle motor 20, and a cover member 32, which is tightly sealed with said housing 31, and which forms a clean space wherein there is extremely little dust, dirt, or the like. The case of the hard disk drive device 30 comprises the housing 31 and the cover member 32.

In this hard disk drive device 30, the spindle motor 20 is secured to the housing 31 through fitting the bottom end cylindrical part 21c of the base 21 of the spindle motor 20 into an attachment hole 31a of the housing 31 and tightening multiple attachment screws 33 that are located on a flange part 21b.

In this way, the motor main unit, including the stator 22 and the rotor 23 of the spindle motor 20, is housed within the case of the hard disk drive device 30. Note that the base 21 of the spindle motor 20 and the housing 31 of the hard disk drive device 30 may be integrated to be a single housing member. The integrated single housing member serves as both a part of the case of the hard disk drive device 30 and the attachment part of the stator 22 of the spindle motor 20.

Note that in the hard disk drive device 30, one hard disk 34, which is a recording disk, is located on the outer peripheral surface of the top edge cylindrical part of the rotor hub 23a of the spindle motor 20. This hard disk 34 is secured to the rotor hub 23a through securing a clamp member 36 using a center pin 35 that fits in the aforementioned screw hole 3a that is formed in the axial center part of the top part of the shaft 3. As a result, the hard disk 34 rotates along with the rotor hub 23a. Note that although a single hard disk 34 is equipped on the rotor hub 23a in the present example of embodiment, instead two or more hard disks 34 may be equipped as desired.

Moreover, the hard disk device 30 is equipped with a magnetic head (recording head) 37 that writes data to and reads data from the hard disk 34, an arm 38 which supports this magnetic head 37, and a voice coil motor 39 which moves the magnetic head 37 and the arm 38 to specific positions. Here the voice coil motor 39 has a coil 39a and a magnet 39b, which is equipped facing said coil 39a.

The aforementioned magnetic head 37 is attached to the tip part of a suspension 40 that is firmly attached to said arm 38, which is supported so as to be able to swivel appropriately within the housing 31. Additionally, this magnetic head 37 may be equipped in a pair of top and bottom magnetic heads, for a single hard disk 34, so as to lie on either side of said hard disk 34, making it possible to read data from and write data to both sides of said hard disk 34.

Moreover, in the hard disk drive device 30 according to the present example of embodiment, an adhesive 13 (see FIG. 1 and FIG. 2) is injected into an adhesive groove 2c of the sleeve 2 from holes 7a, formed in the side surface of the case 7 of the fluid dynamic pressure bearing 1, so that the case 7 and the sleeve 2 are bonded by the adhesive 13, and thus there will be no problems with soiling of said hard disk drive device 30 by the adhesion of the adhesive 13 to parts aside from the intended parts, and thus making it possible to ensure high reliability of said hard disk device 30 through the strong adhesion of the case 7 and the sleeve 21 by the adhesive 13.

Because the hard disk 34 is structured from a single hard disk in the present example of embodiment, a pair of magnetic heads 37 is provided.

Additionally, although in the present example of embodiment the spindle motor 20 was applied to a hard disk drive device 30, [the present invention] is not limited thereto. For example, an optical head may be substituted for the magnetic head, and the spindle motor may be used in a recording disk drive device that drives a recording disk such as a CD or a DVD.

Furthermore, although in the present example of embodiment a rotating axle-type spindle motor 20 equipped with the fluid dynamic pressure bearing 1 and a hard disk drive device 30 equipped with said spindle motor 20 were described, the fluid dynamic pressure bearing 1 according to the present invention can also be applied to stationary-axle-type spindle motors as well. In such a case, the spindle motor is structured by fitting the shaft 3 of the fluid dynamic pressure bearing 1 into the base of the spindle motor, securing the stator, securing the rotor hub to the sleeve through the case 7 of the fluid dynamic pressure bearing 1, and fitting, into the rotor hub, a rotor magnet that generates a rotational magnetic field, working together with the stator.

This invention is useful for spindle motors and other equipment used to drive memory devices for magnetic and optical discs, for driving motors for polygon mirrors used for scanning processes of laser beam printers, and for fluid dynamic pressure bearings used for small driving motors such as axial flow fans.

While a preferred embodiment of the invention has been described, various modifications will be apparent to one skilled in the art in light of this disclosure and are intended to fall within the scope of the appended claims.

1. A fluid dynamic bearing comprising:
a case;
a sleeve fitted into the case;
a rotating shaft inserted in the sleeve;
a groove formed around the outer circumferential surface of the sleeve;
at least one hole, facing the groove, formed in the case; and
an adhesive injected in the groove through the hole to adhere the case to the sleeve.

2. The fluid dynamic pressure bearing of claim 1, wherein the case is constructed by precision press processing.

3. The fluid dynamic pressure bearing according to claim 1, wherein the sleeve is fitted in the case with a gap between the case and the sleeve and the gap is sealed by the adhesive.

4. The fluid dynamic bearing of claim 3, wherein the viscosity of the adhesive is selected so that the adhesive will spread to fill the gap and provide a firm and airtight seal between the case and the sleeve.

5. The fluid dynamic bearing of claim 1, wherein the sleeve is fitted into the case with an interference of 2-3 microns.

6. A spindle motor comprising:
a fluid dynamic bearing, the fluid dynamic bearing comprising:
a case;
a sleeve fitted into the case;
a rotating shaft inserted in the sleeve;
a groove formed around the outer circumferential surface of the sleeve;
at least one hole, facing the groove, formed in the case; and
an adhesive injected in the groove through the hole to adhere the case to the sleeve.

7. The spindle motor of claim 6, wherein the case is constructed by precision press processing.

8. The spindle motor of claim 6, wherein the sleeve is fitted in the case with a gap between the case and the sleeve and the gap is sealed by the adhesive.

9. The spindle motor of claim 8, wherein the viscosity of the adhesive is selected so that the adhesive will spread to fill the gap and provide a firm and airtight seal between the case and the sleeve.

10. The spindle motor of claim 6, wherein the sleeve is fitted into the case with an interference of 2-3 microns.

11. A recording disk drive device comprising:
a spindle motor, the spindle motor comprising:
a fluid dynamic bearing, the fluid dynamic bearing comprising:
a case;
a sleeve fitted into the case;
a rotating shaft inserted in the sleeve;
a groove formed around the outer circumferential surface of the sleeve;
at least one hole, facing the groove, formed in the case, and
an adhesive injected in the groove through the hole to adhere the case to the sleeve.

12. The recording disk drive device of claim 11, wherein the case is constructed by precision press processing.

13. The recording disk drive device of claim 11, wherein the sleeve is fitted in the case with a gap between the case and the sleeve and the gap is sealed by the adhesive.

14. The recording disk drive device of claim 13, wherein the viscosity of the adhesive is selected so that the adhesive will spread to fill the gap and provide a firm and airtight seal between the case and the sleeve.

15. The recording disk drive device of claim 11, wherein the sleeve is fitted into the case with an interference of 2-3 microns.

16. A drive for polygon mirrors of a scanner for scanning a laser beam, the drive comprising:
a motor, the motor comprising:
a fluid dynamic bearing, the fluid dynamic bearing comprising:
a case;
a sleeve fitted into the case;
a rotating shaft inserted in the sleeve;
a groove formed around the outer circumferential surface of the sleeve;
at least one hole, facing the groove, formed in the case; and
an adhesive injected in the groove through the hole to adhere the case to the sleeve.

17. The drive for polygon mirrors of claim 16, wherein the case is constructed by precision press processing.

18. The drive for polygon mirrors of claim 16, wherein the sleeve is fitted in the case with a gap between the case and the sleeve and the gap is sealed by the adhesive.

19. The drive for polygon mirrors of claim 18, wherein the viscosity of the adhesive is selected so that the adhesive will spread to fill the gap and provide a firm and airtight seal between the case and the sleeve.

20. The drive for polygon mirrors of claim 16, wherein the sleeve is fitted into the case with an interference of 2-3 microns.

21. An axial flow fan comprising:
a motor, the motor comprising:
a fluid dynamic bearing, the fluid dynamic bearing comprising:
a case;
a sleeve fitted into the case;
a rotating shaft inserted in the sleeve;
a groove formed around the outer circumferential surface of the sleeve;
at least one hole, facing the groove, formed in the case; and
an adhesive injected in the groove through the hole to adhere the case to the sleeve.

22. The axial flow fan of claim 21, wherein the case is constructed by precision press processing.

23. The axial flow fan of claim 21, wherein the sleeve is fitted in the case with a gap between the case and the sleeve and the gap is sealed by the adhesive.

24. The axial flow fan of claim 23, wherein the viscosity of the adhesive is selected so that the adhesive will spread to fill the gap and provide a firm and airtight seal between the case and the sleeve.

25. The axial flow fan of claim 21, wherein the sleeve is fitted into the case with an interference of 2-3 microns.
